(19) United States
(12) Patent Application Publication
(10) Pub. No.: US 2025/0142199 A1
(43) Pub. Date: May 1, 2025

(54) METHOD, APPARATUS, SYSTEM AND NON-TRANSITORY COMPUTER READABLE MEDIUM FOR ADAPTIVELY ADJUSTING DETECTION AREA

(71) Applicant: NEC Corporation, Minato-ku, Tokyo (JP)

(72) Inventors: Hui Lam ONG, Singapore (SG); Xinlai JIANG, Singapore (SG); Hong Yen ONG, Singapore (SG); Wei Jian PEH, Singapore (SG)

(73) Assignee: NEC Corporation, Minato-ku, Tokyo (JP)

(21) Appl. No.: 18/692,368

(22) PCT Filed: Sep. 28, 2022
(86) PCT No.: PCT/JP2022/036316

§ 371 Date: Mar. 15, 2024

(30) Foreign Application Priority Data
Oct. 14, 2021 (SG) 102021111442R

(51) Int. Cl. H04N 23/611; G06T 7/11; G06V 20/52; G06V 40/16; G06V 40/20; H04N 23/69; H04N 23/695

(52) U.S. Cl. CPC H04N 23/611; G06T 7/11; G06T 2207/20012; G06T 2207/30201; G06T 2207/30232; G06T 2207/30242; G06V 20/53; G06V 40/168; G06V 40/23; H04N 23/69; H04N 23/695

(57) ABSTRACT

A method (300) for adjusting a detection area of an image to be captured by an image capturing device (402) comprises: detecting person appearances in the detection area from input images previously captured by the image capturing device (402) over a period of time (302); generating a map corresponding to the detection area based on the person appearances, wherein the map comprises a measure of the person appearances detected in each of a plurality of portions of the detection area across the input images (304); determining if a ratio of unutilized portions to the plurality of portions exceeds a threshold ratio (306); and adjusting the detection area such that a focus area within the detection area comprising a part of utilized portions is positioned at a center of the adjusted detection area of the image to be captured in response to the determination (308).

### TECHNICAL FIELD

The present invention relates to an image capturing device and a detection area of an image captured by the image capturing device, and more particularly, relates to a method, an apparatus, a system and a program for adaptively adjusting the detection area of an image to be captured by the image capturing device.

### BACKGROUND ART

Millions of surveillance cameras have been deployed around the world for safety measurement in particular public transport hub such as train and bus stations. Most of these images and video footages are achieved without any processing due to real-time video analytics is too resource demanding and requires highly skilled persons to setup and configure it. The images and video footages will be retrieved on-demand for post investigation purpose as evidence.

### SUMMARY OF INVENTION

### Technical Problem

Maintenance of these huge number of surveillance cameras can be very challenging if rely merely on manual human effort as any of the camera can be malfunction or misadjusted at any moment caused by environmental condition changed such as lighting changed, dust/dirt on camera lens, and also external factors including renovation, cleaning services on top of software system and hardware problem or failure.

Further, behavior changes of monitoring objective can be another operational challenge as the surveillance cameras are previously setup for a particular purpose such as monitor the incoming human traffic, but due to renovation work, the human traffic flow might being channeled to another out of focus direction. This may cause the surveillance cameras failing to be implemented according to its original objective, for example, suspicious person detection, scene understanding and evidence collection for post investigation, and to provide useful images and video footage required.

There is thus a need that provide a method, an apparatus, a system and a program to address the abovementioned issues.

Furthermore, other desirable features and characteristics will become apparent from the subsequent detailed description and the appended claims, taken in conjunction with the accompanying drawings and this background of the disclosure.

### Solution to Problem

In a first aspect, the present disclosure provides a method executed by a computer for adaptively adjusting a detection area of an image to be captured by an image capturing device including:
detecting appearances of one or more persons in the detection area from each of a plurality of input images previously captured by the image capturing device over a period of time;
generating a first map corresponding to the detection area based on the respective appearances of the one or more persons, wherein the first map comprises a first measure of the appearances of the one or more persons detected in each of a plurality of portions of the detection area across the plurality of the input images;
determining if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjusting the detection area such that a focus area within the detection area which comprises at least a part of utilized portions of the plurality of portions is positioned at or near to a center of the adjusted detection area of the image to be captured by the image capturing device in response to the determination.

In a second aspect, the present disclosure provides an apparatus for adaptively adjusting a detection area of an image to be captured by an image capturing device comprising:
at least one processor; and
at least one memory including computer program code, wherein
the at least one memory and the computer program code are configured to, with at least one processor, cause the apparatus at least to:
detect appearances of one or more persons in the detection area from each of a plurality of input images previously captured by the image capturing device over a period of time;
generate a first map corresponding to the detection area based on the respective appearances of the one or more persons, wherein the first map comprises a first measure of the appearances of the one or more persons detected in each of a plurality of portions of the detection area across the plurality of the input images;
determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjust the detection area such that a focus area within the detection area which comprises at least a part of utilized portions of the plurality of portions is positioned at or near to a center of the adjusted detection area of the image to be captured by the image capturing device in response to the determination.

In a third aspect, the present disclosure provides a system for adaptively adjusting a detection area of an image to be captured by an image capturing device comprising the apparatus according to the second aspect and the image capturing device.

In a fourth aspect, the present disclosure provides a non-transitory computer readable medium storing a program for adaptively adjusting a detection area of an image to be captured by an image capturing device, wherein the program causes a computer at least to:
detect appearances of one or more persons in the detection area from each of a plurality of input images previously captured by the image capturing device over a period of time;
generate a first map corresponding to the detection area based on the respective appearances of the one or more persons, wherein the first map comprises a first measure of the appearances of the one or more persons detected in each of a plurality of portions of the detection area across the plurality of the input images;
determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjust the detection area such that a focus area within the detection area which comprises at least a part of utilized portions of the plurality of portions is positioned at or near to a center of the adjusted detection area of the image to be captured by the image capturing device in response to the determination.

Additional benefits and advantages of the disclosed example embodiments will become apparent from the specification and drawings. The benefits and/or advantages may be individually obtained by the various example embodiments and features of the specification and drawings, which need not all be provided in order to obtain one or more of such benefits and/or advantages.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1A shows an image capturing device (e.g., camera) configured with an objective to perform a video analytics detection to detect a person appearance within a detection area.

FIG. 1B shows the image capturing device of FIG. 1A performing the video analytics detection to detect a person appearance within the detection area when there is a change of human traffic or environment.

FIG. 1C shows a focus area within an image (or field of view) of the camera of FIG. 1B and a field of view adjustment to the camera according to an example embodiment of the present disclosure.

FIG. 2 shows outputs of different video analytics detections performed on an input image therein according to an example embodiment of the present disclosure.

FIG. 3 shows a flow chart illustrating a method for adaptively adjusting a detection area of an image to be captured by an image capturing device according to various example embodiments of the present disclosure.

FIG. 4 shows a block diagram illustrating a system for adaptively adjusting a detection area of an image to be captured by an image capturing device according to various example embodiments of the present disclosure.

FIG. 5 shows a flow diagram illustrating a system performing a part of operations to adaptively adjust a detection area of an image capturing device according to an example embodiment of the present disclosure.

FIG. 6 shows a flow diagram illustrating the system of FIG. 5 performing another part of operations to adaptively adjust a detection area of an image capturing device.

FIG. 7 shows a flow diagram illustrating a process of generating detection maps and a combined detection map based on appearances of one or more person detected from input images according to an example embodiment of the present disclosure.

FIG. 8 shows a flow diagram illustrating a process of generating an analytic density map based on appearances of a person detected across multiple input images captured by a camera according to an example embodiment of the present disclosure.

FIG. 9 shows an example analytic density map generated based on appearances of multiple persons detected from multiple input images previously detected by a camera over a period of eight hours according to an example embodiment of the present disclosure.

FIG. 10 shows unutilized portions and utilized portions of the detection area based on the analytic density map of FIG. 9 according to an example embodiment of the present disclosure.

FIG. 11 shows the highest measure of appearances generated in the analytic density map of FIG. 9 according to an example embodiment of the present disclosure.

FIG. 12 shows a focus area selected from utilized portions based on the measure of appearances generated in the analytic density map of FIG. 9 according to an example embodiment of the present disclosure.

FIG. 13 shows a reference centralized portion within a detection area for a focus area according to an example embodiment of the present disclosure.

FIG. 14 shows a field of view adjustment to reposition a focus area to be at a reference centralized portion within the detection area according to an example embodiment of the present disclosure.

FIG. 15 shows a change in a magnification of an image capturing device for adjusting a detection area according to an example embodiment of the present disclosure.

FIG. 16 shows an example camera view adjustment corresponding to an adjustment in a detection area to reposition a focus area to a reference centralized portion using pixel coordinate difference and angular field of view (AFOV) according to an example embodiment of the present disclosure.

FIG. 17 shows example camera zoom adjustment corresponding to an adjustment in a detection area according to an example embodiment of the present disclosure.

FIG. 18 shows a flow chart illustrating a process of adaptively adjusting a detection area of an image to be captured by an image capturing device according to an example embodiment of the present disclosure.

FIG. 19 shows a flow chart illustrating a process of performing and storing a first level analytics detection in person appearance database in FIG. 18 according to an example embodiment of the present disclosure.

FIG. 20 shows a flow chart illustrating a process of processing utilized space to generate camera view adjustment suggestion in FIG. 18 according to an example embodiment of the present disclosure.

FIG. 21 shows a schematic diagram illustrating an overview of a process of adaptively adjusting a detection area of an image to be captured by an image capturing device according to an example embodiment of the present disclosure.

FIG. 22 shows a schematic diagram of an exemplary computing device suitable for use to execute the method in FIG. 3 and implement the apparatus in FIG. 4.

FIG. 23 shows a block diagram illustrating an apparatus for adaptively adjusting a detection area of an image to be captured by an image capturing device according to various example embodiments of the present disclosure.

### DESCRIPTION OF EMBODIMENTS

### Terms Description

Detection area—a detection area of an image captured by an image capturing device may correspond to a field of view of the image capturing device. In various example embodiments below, the term “detection area” and “field of view” are used interchangeably. A field of view of an image capturing device can be adjusted by (i) rotating the image capturing device around a horizontal axis, i.e., a pan adjustment, and/or a vertical axis, i.e., a tilt adjustment, to change a horizontal and/or a vertical device angle of the image capturing device in relation to the field of view to have a different field of view, and/or (ii) increasing/decreasing a magnification of the image capturing device, i.e., a zoom adjustment, and result in a different detection area of an image to be captured by the image capturing device. A detection area reflected in an image can be divided or segmented into a plurality of portions. For sake of simplicity, various example embodiments of the present disclosure illustrate grid segmentations onto the detection area where the detection area reflected in an image is divided into a plurality of equal portions, i.e., squared areas or grid cells, such that the detection area turns into a grid map. X- and y-coordinates may be used to designate the division lines and locate each cell. The image or the detection area of the image can then be analysed and processed portions by portions. It is appreciated that other segmentation methods using symmetrical/asymmetrical, equal/unequal shapes, areas and sizes may be used. In various example embodiments, a same detection area reflected in multiple input images is subjected to a same division and segmentation into a same plurality of portions such that each portion reflects a same portion of the detection area across multiple input images. Each image or the detection area of each image will also be subjected to a same analysis and processing, portions by portions.

Appearance—an appearance of a person in an image is detected based on a facial feature, a body part, a characteristic and a motion of the person or a combination thereof. Examples of a facial feature includes relative position, size, shape and/or contour of eyes, nose, cheekbones, jaw and chin, and also iris pattern, skin colour, hair colour or a combination thereof. A characteristic includes physical characteristic such as height, body size, body ratio, length of limbs, hair colour, skin colour, apparel, belongings, other similar characteristics or combinations. A motion may include behavioural characteristic such as body movement, position of limbs, direction of movement, moving speed, walking patterns, the way a person stands, moves, talks, other similar characteristics or combinations.

In various example embodiments, each image is subjected to at least two appearances detections and measurements (may hereinafter be referred to as video analytics detection) based on different facial features, body parts, characteristics, motions or combinations thereof. For example, a face detection and a posture detection may be carried out in an image to detect appearances of all persons in that image. Such multiple appearances detections can be used to provide more comprehensive person appearance measurements for detection area adjustment.

Alternatively or additionally, each image may be subjected to only one video analytics detection based on one facial feature, body part, characteristic, motion or a combination thereof (e.g., face detection) to ensure only images with appearances detected is stored in a database for further processing. Subsequently, the images in the database which were taken over a time period may be subsequently retrieved and subjected to at least one other video analytics detection based on another different facial feature, body part, characteristic, motion or a combination thereof (e.g., posture detection).

Measure of appearances—a measure of appearances generally relates to a count of appearances detected, for example, within a portion, multiple portions or whole of a detection area of an input image or within a same portion, multiple same portions or whole of a same detection area of multiple input images. In various example embodiments of the present disclosure, an image capturing device is pre-configured with a detection weightages profile, where each count of appearance detected based on a different facial feature, body part, characteristic, motion or combination thereof by the image capturing device is further subjected to (e.g., increased or multiplied by) a different detection weightage, thereby resulting in a different measure of appearances. Such profile of detection weightages may be pre-configured for an image capturing device by a user based on an objective for which the image capturing device is used, put in place or configured to perform.

Map—a map refers to a two-dimensional (2D) data array comprising a compilation of measures of appearances determined in every segmented portion of the detection area. A map can also be combined with another map by summing the measures of appearances in corresponding portions determined in the two maps.

Similarly, each segmented portion of the detection area is subjected to at least two appearances detections and measurements based on different facial features, body parts, characteristics and motions or combinations thereof image. For example, a face detection and a posture detection may be carried out in every segmented portion of the detection area to detect if person appearances (faces and postures of any person in this case) are detected in that portion. The same effect may be achieved by determining which segmented portions that the detected appearances (faces and postures in this case) fall into.

As a result, at least two different detection maps can be generated from an image, by measuring person appearances detected from every segmented portion of the detection area based on the different facial features, body parts, characteristics and motions or combinations thereof. Additionally, different detection maps generated from an image may be combined to form a combined detection map. Also additionally, different combined detection maps generated from different images taken over a period of time may be combined to form an analytic density map where a measure of appearances of all persons in every segmented portion of the detection area over the period of time can be reflected and analysed using the analytic density map.

Unutilized portion—an unutilized portion refers to a segmented portion of a detection area in which no appearance is detected. In other words, such segmented portion will be associated with no measure of appearances or a measure of appearance being zero.

Utilized portion—a utilized portion refers to a segmented portion of a detection area in which at least one appearance of one person is detected. In other words, such segmented portion will be associated with a measure of appearances that is of non-zero value.

Focus area—A focus area refers to an area of interest within a detection area or field of view of an image capturing device. In various example embodiments, a focus area relates to a portion (or multiple portions) in which a higher measure(s) of appearances is determined as compared to the remaining area of the detection area. In various example embodiments below, if the focus area is departed from a center or a pre-configured center portion of the detection area or field of view of an image capturing device, an adjustment to the detection area or field of view of the image capturing device will be carried out such that the focus area will be at or near to the center or pre-configured center portion of the adjusted detection area or field of view of the image capturing device. As such, images to be captured by the image capturing device having the adjusted detection area or field of view will have a greater likelihood to detect person appearances near or at the center or pre-configured center portion of the images.

### Exemplary Embodiments

Exemplary embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “receiving”, “calculating”, “determining”, “updating”, “generating”, “initializing”, “outputting”, “receiving”, “retrieving”, “identifying”, “dispersing”, “authenticating” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

Various example embodiments of the present disclosure relate to a method and an apparatus for adaptively adjusting a detection area of an image to be captured by an image capturing device. It is appreciated by a skilled person that such apparatus and the image capturing device may be implemented as part of a system to provide the same technical effect.

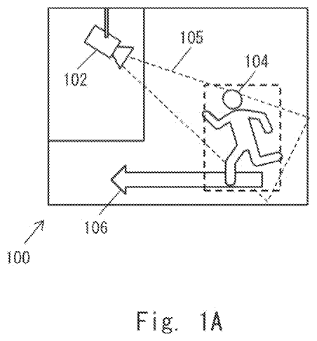

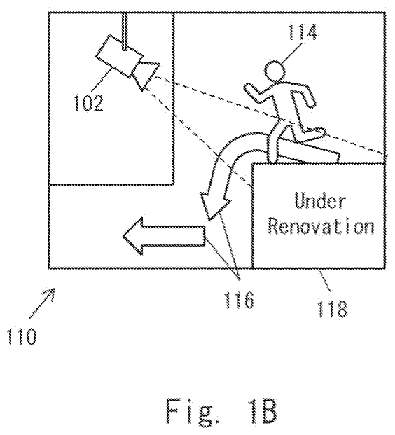

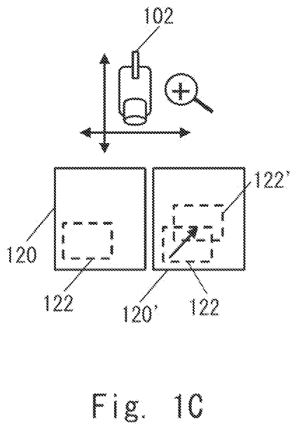

FIG. 1A shows an image capturing device (e.g., camera 102) configured with an objective to perform a video analytics detection to detect a person appearance within a detection area. The detection area corresponds to the field of view 105 of the camera 102. In this example, the camera 102 may have been configured (e.g., by a user) with a detection/monitoring objective to detect a person appearance based on a combination of body and face detections, and the camera 102 was setup before a renovation is carried out in the detection area. Normally, an appearance 104 of a person who was moving in a direction 106 into the detection area, i.e., field of view 105 of the camera 102 would be captured and detected in an image 100 of the camera 102.

FIG. 1B shows the image capturing device of FIG. 1A performing the video analytics detection to detect a person appearance within the detection area when there is a change of human traffic or environment. As described above, human traffic flow might change, or be channeled to another out of focus direction due to the renovation carried out in the detection area (shown in box 118). Due to the renovation, a person 114 would now move in a direction 116 around the detection area, and the camera 102 which is originally configured to perform both body and face detections in order to detect a person appearance within a detection area would then fail to detect the person appearance and carry out its objective.

There is thus a need to provide a method and an apparatus capable of adaptively adjusting the field of view (and thus the detection area) of the camera 102 to adopt such changes in human traffic and environment. FIG. 1C shows a focus area 122 within an image 120 (i.e., field of view or detection area) of the camera 102 of FIG. 1B and a field of view adjustment to the camera 102 according to an example embodiment of the present disclosure. A focus area 122 is an area of interest where a high measure of appearances is determined as compared to the remaining area of the image 120. In this example embodiment, the focus area at the left bottom corner of the image 120 is determined to have a higher measure of appearances than the remaining area of the image 120, an adjustment to the field of view 120 of the camera is then carried out such that the focus area 122 will shifted to be at or near to a pre-configured portion thereof, in this case a pre-configured centre portion shown in dashed box 122′. As such, subsequent images to be captured by the camera 102 under the adjusted field of view 120′ will have a greater likelihood to detect person appearances near or at the pre-configured portion 122′ of the images 120′.

According to the present disclosure, the method and apparatus for adaptively adjusting a detection area of an image to be captured by an image capturing device provides advantages in collecting evidence and data of person appearances (or presence) in series of images or videos by using human/body detection without the need of human involvement.

Besides, it is noted that each video analytics detection (e.g., body detection, pose detection, face detection) has its own advantages. For example, body detection can detect smaller appearance size of person compared to face detection analytics, while pose detection can detect more person appearance detail such as body posture/gesture of a person compared to body detection analytics. The method and apparatus according to the present disclosure also provides advantages in combining on-demand multiple video analytics detections (e.g., body detection and pose detection) to help to provide more comprehensive person appearances detection and detection area adjustment.

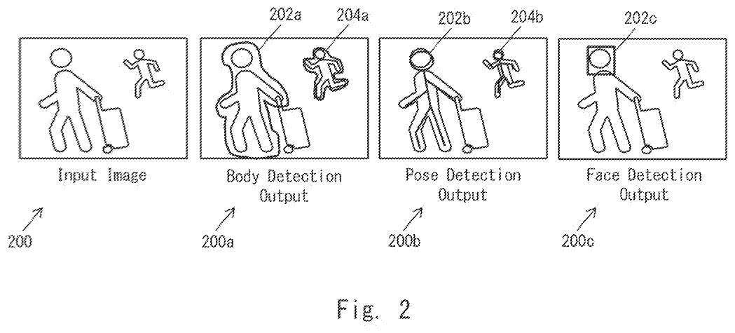

FIG. 2 shows outputs 202a-202c of different video analytics detections performed on an input image 200 according to an example embodiment of the present disclosure. In this example embodiment, three different video analytics detections are performed on the input image 200: body detection, post detection and face detection. Their detection outputs are illustrated in images 200a, 200b and 200c respectively. Two person appearances 202a, 204a can be detected using body detection, two person appearances 202b, 204b can also be detected using pose detection; and only one person appearance 202c is detected using face detection as the appearance of another person may be too small for face detection.

According to the present disclosure, the method and apparatus also provide that an image capturing device may be (pre-) configured, for example by a user, with an objective for which the image capturing device is used, put in place or configured to perform. Examples of an objective includes face recognition, action recognition or crowd estimation. Each objective has a different detection weightages profile where different video analytics detections are performed and different detection weightages are applied to different video analytics detections as well. For example, an image capturing device may be configured with an objective to perform face recognition where body detection and face detection are carried out for each image at respective detection weightages of 1 and 3. This means that, an appearance detected through a person's face from an image is given higher measure/count (3 times higher) than an appearance detected through a person's body from the same image. On the other hand, under action recognition, the image capturing device may be configured to perform body detection, face detection and pose detection at respective detection weightages of 1, 2 and 3; and under crowd estimation, body detection and pose detection are performed at respective detection weightages of 1 and 3.

Advantageously, an area of interest or a focus area (e.g., focus rectangle) is determined based on the detection weightages profile relating to the pre-configured objective of the image capturing device, and its field of view and detection area is adjusted based on the focus area for the image capturing device to better perform video analytics detections according to its pre-configured detection and monitoring objective.

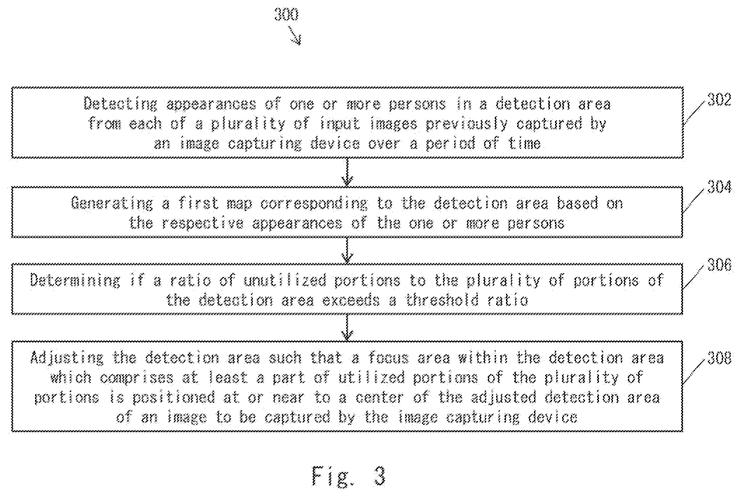

FIG. 3 shows a flow chart illustrating a method for adaptively adjusting a detection area of an image to be captured by an image capturing device according to various example embodiments of the present disclosure. In step 302, a step of detecting appearances of one or more persons in a detection area from each of a plurality of input images previously captured by an image capturing device over a period of time is carried out. In step 304, a step of generating a first map corresponding to the detection area based on the respective appearances of the one or more persons is carried out. The map comprises a first measure of the appearances of the one or more persons detected in each of a plurality of portions of the detection area across the plurality of the input images. In step 306, a step of determining if a ratio of unutilized portions to the plurality of portions of the detection area exceeds a threshold ratio is carried out. Each of the unutilized portions is a portion of the plurality of portions of the detection area associated with no first measure of appearances or a first measure of appearances being zero, indicating no appearances of the one or more persons were detected in that portion across the plurality of input images. In step 308, a step of adjusting the detection area such that a focus area within the detection area which comprises at least a part of utilized portions of the plurality of portions is positioned at or near to a center of the adjusted detection area of an image to be captured by the image capturing device in response to the determination in step 306.

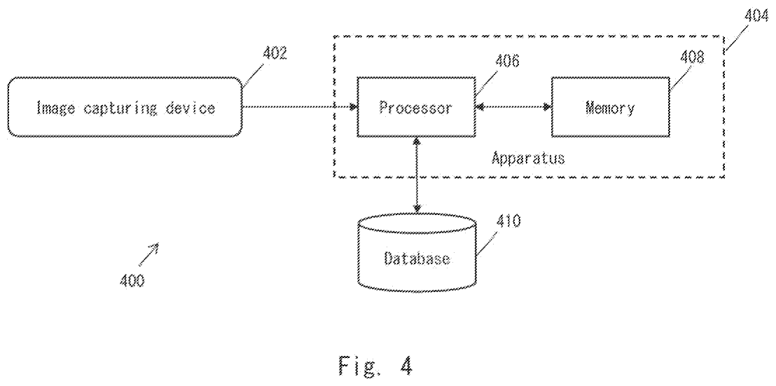

FIG. 4 shows a block diagram illustrating a system 400 for adaptively adjusting a detection area of an image to be captured by an image capturing device 402 according to various example embodiments of the present disclosure.

In an example, the managing of image input is performed by at least an image capturing device 402 and an apparatus 404. The system 400 comprises an image capturing device 402 in communication with the apparatus 404. In an implementation, the apparatus 404 may be generally described as a physical device comprising at least one processor 406 and at least one memory 408 including computer program code. The at least one memory 408 and the computer program code are configured to, with the at least one processor 406, cause the physical device to perform the operations described in FIG. 3. The processor 406 is configured to receive a plurality of input images from the image capturing device 402 or retrieve a plurality of input images from a database. Alternatively or additionally, the plurality of input images captured by the image capturing device 402 is stored in a database 410, and the processor 406 is configured to retrieve the plurality of input images from the database 410.

The image capturing device 402 may be a device such as a closed-circuit television (CCTV) which provides a variety of data of which appearance data that can be used by the system to detect appearances of one or more persons. In an implementation, the appearance data derived from the image capturing device 402 may be stored in memory 408 of the apparatus 404 or a database 410 accessible by the apparatus 404. The appearance data may include (i) facial feature data such as relative position, size, shape and/or contour of eyes, nose, cheekbones, jaw and chin, and also iris pattern, skin colour, hair colour or a combination thereof, (ii) physical characteristic data such as height, body size, body ratio, length of limbs, hair colour, skin colour, apparel, belongings, other similar characteristics or combinations, and (iii) behavioral characteristic data such as body movement, position of limbs, direction of movement, moving speed, walking patterns, the way a person stands, moves, talks, other similar characteristics or combinations.

In an implementation, camera data such as location and resolution, and/or time data which includes a timestamp at which the one or more persons are identified may also be derived from the image capturing device 402. The camera data and/or time data may be stored in memory 408 of the apparatus 404 or a database 410 accessible by the apparatus 404 and the processor 406 is configured to identify and retrieve appearance data or images based on the time data. It should be appreciated that the database 410 may be a part of the apparatus 404.

The apparatus 404 may be configured to communicate with the image capturing device 402 and the database 410. In an example, the apparatus 404 may receive, from the image capturing device 402, or retrieve from the database 410, a plurality of images relating to a same field of view of the image capturing device as input, and after processing by the processor 406 in apparatus 404, generate an output which may be used to adjust the field of view of the image capturing device 402 for capturing subsequent images.

According to the present disclosure, after receiving an image from the image capturing device 402, or retrieve an image from the database 410, the memory 408 and the computer program code stored therein are configured to, with the processor 406 cause the apparatus 404 to detect appearances of one or more persons in the detection area from each of a plurality of input images previously captured by the image capturing device over a period of time: generate a first map corresponding to the detection area based on the respective appearances of the one or more persons, wherein the first map comprises a first measure of the appearances of the one or more persons detected in each of a plurality of portions of the detection area across the plurality of the input images; determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and adjust the detection area such that a focus area within the detection area which comprises at least a part of utilized portions of the plurality of portions is positioned at or near to a center of the adjusted detection area of the image to be captured by the image capturing device in response to the determination.

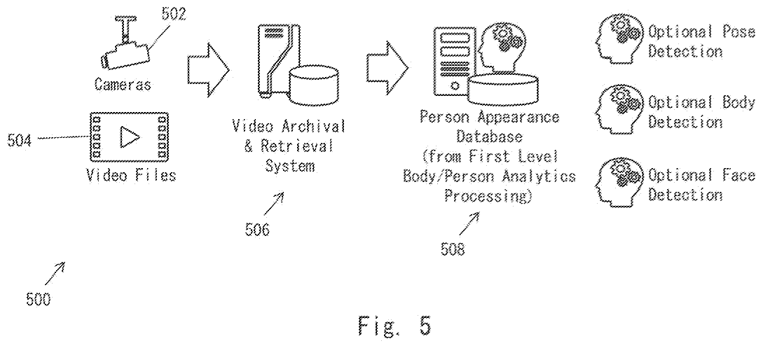

FIG. 5 shows a flow diagram illustrating a system 500 performing a part of operations to adaptively adjust a detection area of an image capturing device according to an example embodiment of the present disclosure. The system may comprise a video archival and retrieval system 506 configured to retrieve a series of input images captured by each of the cameras 502 (e.g., historical sequence of images or video files 504 from online video archival system or offline video files input) and perform first level video analytics detection (e.g., body/face detections). First level video analytics detection output (e.g., detected person appearance data) and its corresponding input image will be stored in person appearance database 508 together with all the necessary camera information such as location, resolution, timestamp. In one example, input images that do not have analytics detection output, i.e., no person appearance is detected based on the video analytics detection, will be discarded and are not stored in the person appearance database 508 for further processing. In various example embodiments, the person appearance database 508 is configured to retrieve the images and detection data for additional and optional pose, body and face detections.

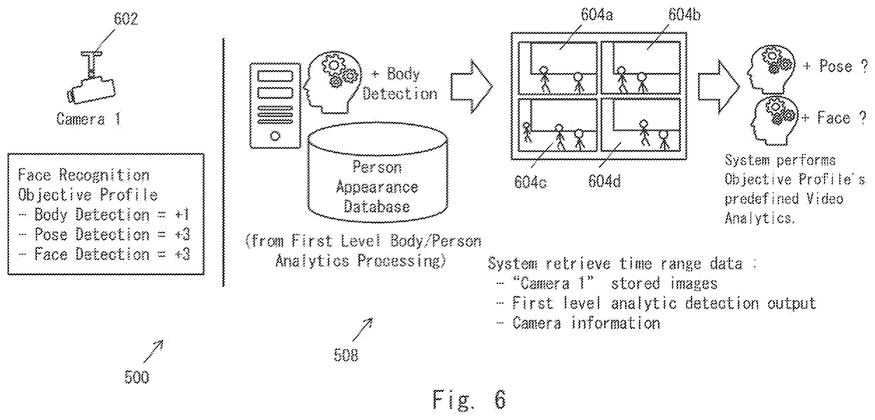

FIG. 6 shows a flow diagram illustrating the system 500 of FIG. 5 performing another part of operations to adaptively adjust a detection area of an image capturing device. A user may specify an image capturing device, in this case camera 1 602, a time range for analysis, and images 604a-604d captured within the time period (or associated with the time data) will be retrieved as input, together with all related information such as the first level detection output and the camera information will be retrieved from the person appearance database 508 for further processing. According to the present disclosure, each of the cameras 502 (including camera 1 602) is configured with an objective for which the camera is used, put in place or configured to perform. In this case, camera 1 602 is configured with a face recognition objective profile, and thus body detection, pose detection and face detection are performed and are given detection weightages of 1, 3 and 3 respectively. As the first level video analytics on body detection has been carried out, the system 500 may then, based on the pre-defined face recognition objective profile, perform on-demand additional video analytics on pose detection and face detection using the retrieved input images 604a-604d to fulfil the objective profile requirement.

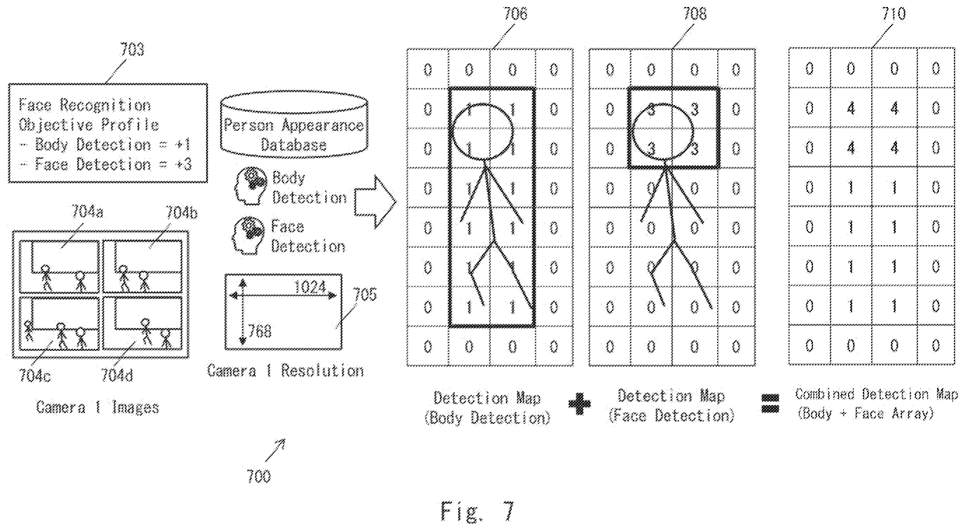

FIG. 7 shows a flow diagram 700 illustrating a process of generating detection maps 706, 708 and a combined detection map 710 based on appearances of one or more person detected from input images 704a-704d according to an example embodiment of the present disclosure. Input images 704a-704d reflecting a same detection area or field of view of camera 1 taken over the selected time period and camera 1 data such as objective profile 703 and resolution (e.g., 1024×768) as illustrated in 705 are retrieved. Based on the objective profile 703, video analytics on body detection and face detection should be performed on each of the input images 704a-704d at detection weightages of 1 and 3 respectively.

For each retrieved image, a 2D array memory storage is constructed according to the selected camera 1's resolution per video analytics and initialized the 2D array detection map with value of 0. According to an example embodiment of the present disclosure, the detection area of each retrieved image 704a-704d is divided into multiple square grid cells to form 2D array detection map according to the selected camera 1's resolution 705. The 2D array detection map is initialized with a value of 0. A measure of appearances is determined for each of the cells of the 2D array detection map based on appearances of the one or more persons detected within the 2D array per video analytics detection, and thus a 2D array detection map reflecting a compilation of measures of appearances across all the cells is generated for each video analytics detection.

Detection maps 706, 708 illustrates a part of the detection maps generated from one single input image (704a, 704b, 704c or 704d) where an appearance of a person is detected based on body detection and face detection respectively. A person appearance is detected in 12 cells of the detection map 706 based on body detection and 4 cells of the detection map 708 based on face detection. While such detection of an appearance constitutes a count of appearance in the respective cells in which the appearance is detected, a measure of appearance (i.e., output of video analytics detection output) is increased based on respective detection weightages of the video analytics detections. In this example embodiment, the detection weightages of body detection and face detection are 1 and 3, respectively, the 12 cells where the person appearance is detected through body detection will thus have a measure of appearance of 1, as shown in detection map 706; whereas the 4 cells where the person appearance is detected through face detection face will thus have a measure of appearance of 3, as shown in detection map 708.

Additionally, a 1024×768 combined detection map (only part of the combined detection map 710 is shown) is generated illustrating the person appearances detected within the same detection area of field of view of camera 1 through multiple video analytic detections from the input image (704a, 704b, 704c or 704d) by summing up the measures of appearances in multiple detections map 706, 708 correspondingly.

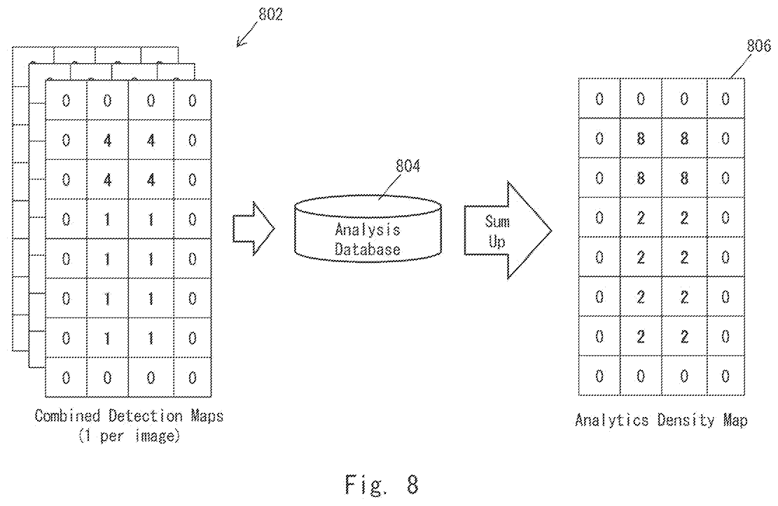

FIG. 8 shows a flow diagram illustrating a process of generating an analytic density map based on appearances of a person detected across multiple input images captured by a camera according to an example embodiment of the present disclosure. A combined detection map reflecting a same field of view is generated from each input image and stored in an analysis database 804. The combined detection maps 802 generated from multiple input images having the same field of view within the selected time period are then retrieved from the analysis database 804 to generate an analytic density map by summing up the measures of appearances in all the retrieved combined detection maps 802 correspondingly. According to the present disclosure, such analytic density map 806 illustrates the measure of appearances of all persons (may hereinafter referred to as “detection density value”) in every cell detected over the selected period of time, and can be used for further processing and analysis for adjusting the detection and field of view of the camera.

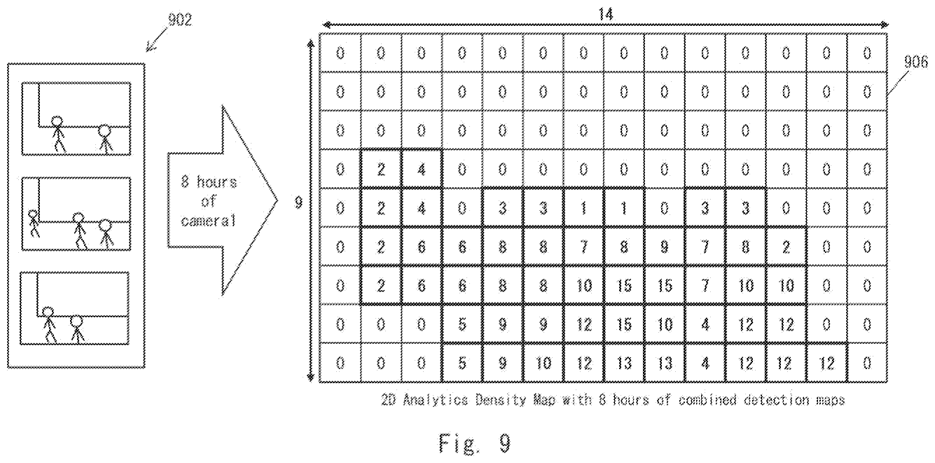

FIG. 9 shows an example analytic density map 906 generated based on appearances of multiple persons detected from multiple input images previously detected by a camera (in this case, camera 1) over a period of eight hours according to an example embodiment of the present disclosure. For the sake of simplicity, the 2D analytic density map 906 with a resolution of 14×9 (width×height) is illustrated. The value of each cell in the analytic density map 906 is calculated by summing up combined detections maps generated from multiple images 902 with the same resolution of 14×9 captured by camera 1 over the eight hours period.

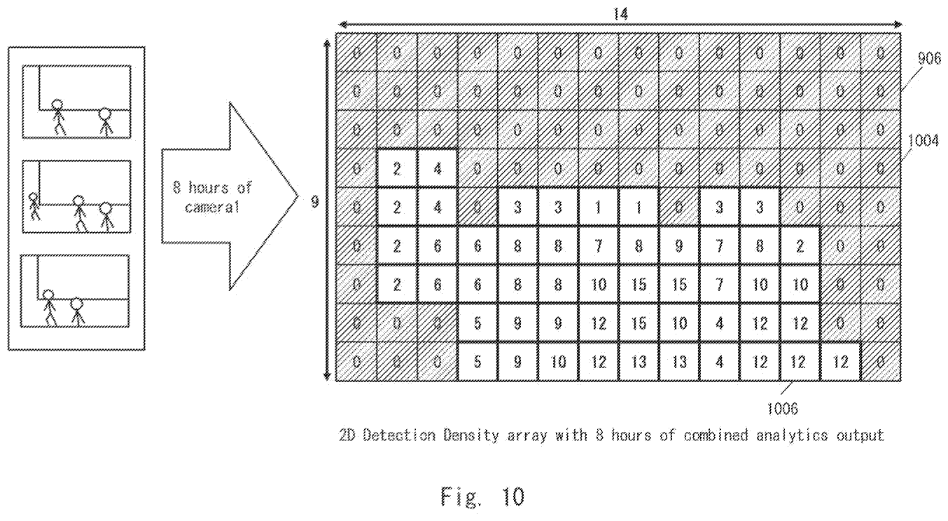

FIG. 10 shows unutilized portions and utilized portions of the detection area based on the analytic density map of FIG. 9 according to an example embodiment of the present disclosure. An unutilized portion or space is a portion within the detection area where no appearance is detected over the selected time period. Such unutilized portion or space is reflected as zero measure of appearances in the analytic density map 906, as shown using hatched blocks 1004 in FIG. 10. On the other hand, a utilized portion or space is a portion within the detection where at least one person appearance is detected over the selected time period, and such utilized portion or space is reflected as non-zero measure of appearances in the analytic density map 906, as shown using blocks 1006 in white background in FIG. 10. According to the present disclosure, an unutilized space percentage is calculated using equation (1):

$$\begin{matrix}( Equation 1 ) & \\ Unutilized space percentage ( \% ) = \frac{Number of unutilized spaces}{Number of total spaces} & Equation ( 1 )\end{matrix}$$

where the number of total spaces refers to the total number of cells (portions or spaces) from the detection area in the analytic density map according to the camera resolution.

In this example embodiment, the camera resolution is 14×9 in terms of width×height (or column×row) and the detection area is segmented to multiple cells with a resolution of 1×1. The unutilized space percentage of the analytic density map 906 is thus 51/(9×14)=51/126=0.404761 or 40.4761%. Such unutilized space percentage will then be checked if it is above a pre-configured under-utilized threshold. If the utilized space percentage is above the under-utilized threshold, subsequent step of determining a focus area within the detection area is carried out; otherwise, no further action or process is carried out. In this case, the pre-configured under-utilized threshold is 0.4 or 40%. As the unutilized space percentage is higher than the under-utilized threshold, the system may proceed to perform a focus area determination step described in the following.

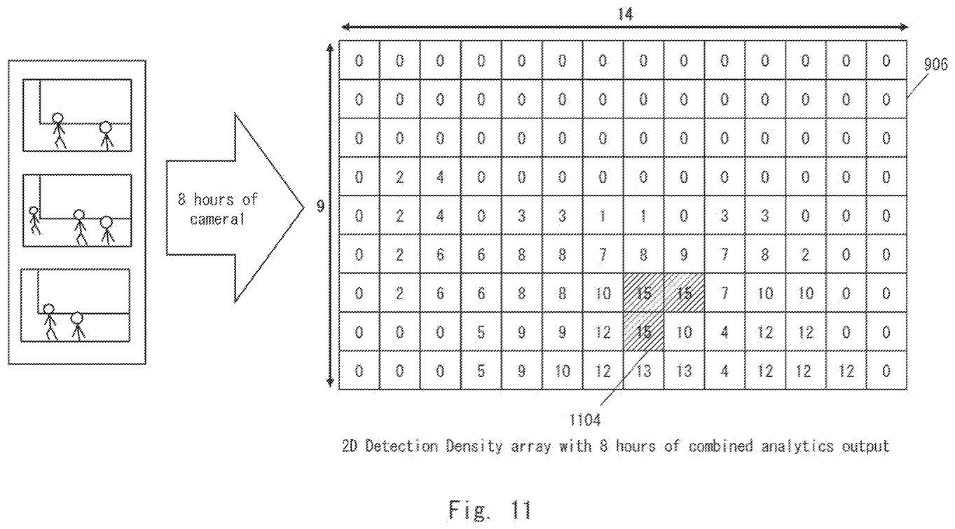

A focus area (hereinafter may be referred to as focus rectangle) within the detection area may be determined using a detection density value range. The process may start by finding a maximum density value within the 2D analytic density map. FIG. 11 highlights the highest measure of appearances generated in the analytic density map 906 of FIG. 9 according to an example embodiment of the present disclosure in hatched blocks 1104.

Subsequently, a minimum density value of the focus area is determined based on the maximum density value. In one example embodiment, a minimum density value is calculated by using pre-defined focus density threshold or multiplier multiplied with the maximum density value. In this case, where the pre-defined focus density threshold is 0.6, the minimum density value is 15×0.60 or 9. As such, a detection density range of 9 to 15 is determined for locating the focus rectangle.

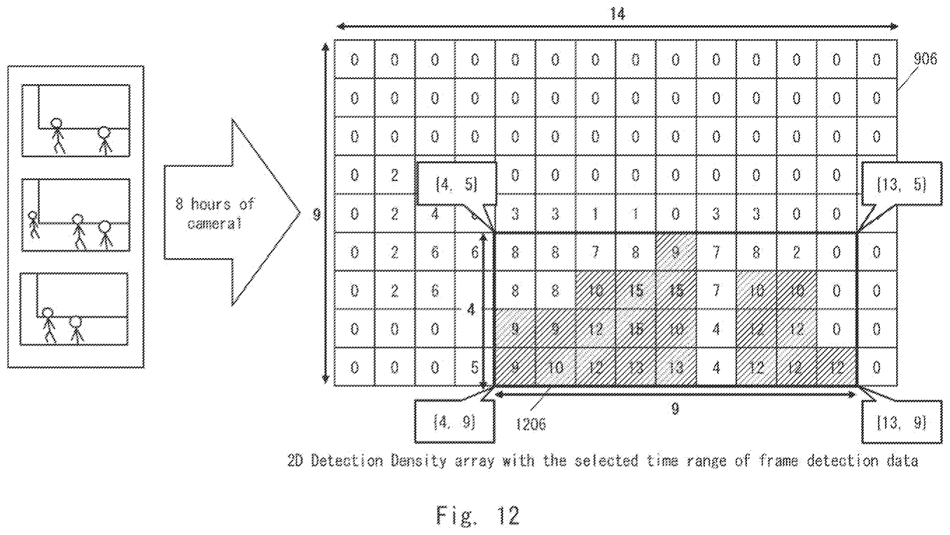

FIG. 12 shows a focus area selected from utilized portions based on the measure of appearances generated in the analytic density map of FIG. 9 according to an example embodiment of the present disclosure. The minimum density value of 9 is used, compared against the measures of appearances of all the utilized portions within the analytic density map 906 and identify a part of the utilized portions having a measure of appearances higher than the minimum density value. The identified utilized portions having a measure of appearances higher than the minimum density value are illustrated in hatched blocks in FIG. 12. A rectangular area 1206 enclosing all the identified utilized portions is determined as the focus rectangle 1206. The x- and y-coordinates of four edges forming the focus rectangle 1206 within the map 906 are also identified.

In one example, the focus rectangle is identified by first identifying the coordinates of each of the identified utilized portions having a density value fall within the range between the minimum density value to maximum density value and four edges of the focus rectangle by minimum and maximum coordinates among the identified utilized portions. In this case, the maximum x-coordinates are 4 and 13 and the maximum y-coordinates are 5 and 9, and thus the coordinates of the four edges of {4, 5}, {4, 9}, {13, 5} and {13, 9} defining the focus rectangle are identified.

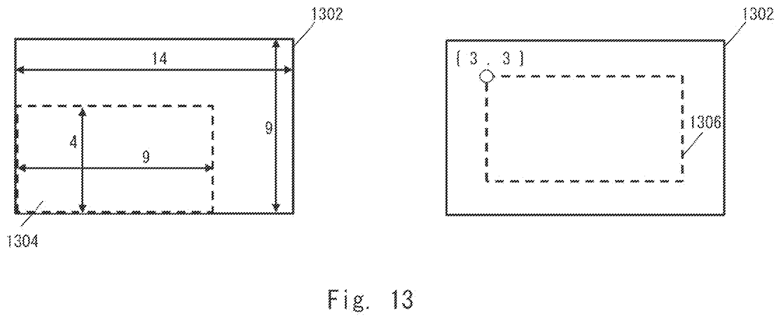

FIG. 13 shows a reference centralized portion within a detection area 1302 for a focus area 1304 according to an example embodiment of the present disclosure. A reference centralized portion or position 1306 for a determined focus rectangle 1304 can be calculated using the width and height of the focus rectangle 1304 (9×4 in this case) and the width and height of the detection area or map 1302 (14×9). In particular, the x- and y-coordinates of top left edge of the reference centralized portion 1306 may be calculated using the following equations:

$$\begin{matrix}( Equation 2 ) & \\ x = Math . ceil ( ( \frac{Total width}{2} ) - ( \frac{Focus width}{2} ) ) & Equation ( 2 )\end{matrix}$$

$$\begin{matrix}( Equation 3 ) & \\ y = Math . ceil ( ( \frac{Total height}{2} ) - ( \frac{Focus height}{2} ) ) & Equation ( 3 )\end{matrix}$$

where total width is the width of the detection area (14 in this example embodiment), total height is the height of the detection area (9 in this example embodiment), focus width is the width of the focus rectangle (9 in this example embodiment) and focus height is the height of the focus rectangle (4 in this example embodiment). The x- and y-coordinates of top left edge of the reference centralized portion 1306 is {3,3}.

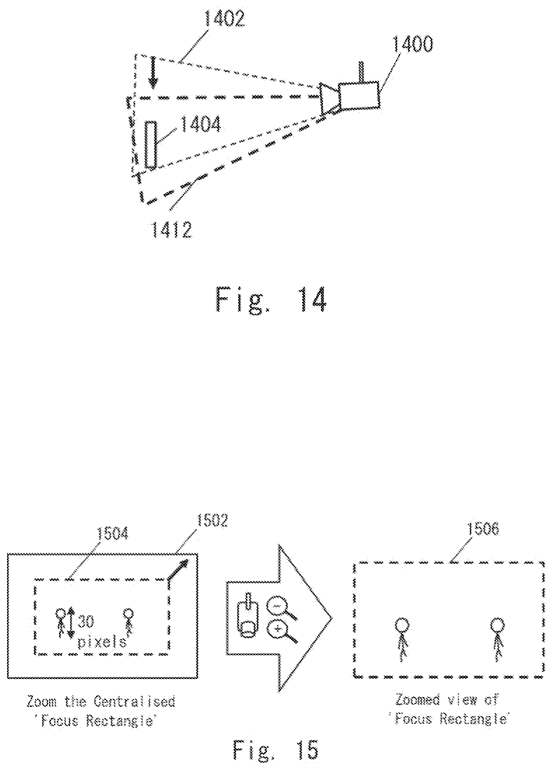

FIG. 14 shows a field of view adjustment to reposition a focus area 1404 to be at a reference centralized portion within the detection area according to an example embodiment of the present disclosure. Once the x- and y-coordinates of the focus rectangle and its reference centralized portion within the detection area are identified, a change in camera settings needed in order to adjust the current field of view 1402 of the camera 1400 to a new field of view 1412 so as to reposition the focus rectangle 1404 to the reference centralized portion can be determined. Examples of calculation of pan, tilt and zoom adjustments required to reposition the focus area 1404 to be at a reference centralized portion within the detection area are elaborated in FIGS. 16 to 18 and their accompanying descriptions.

The current camera settings (e.g., pan angle, tilt angle and zoom value) in relation to the current field of view 1402 of the camera 1400 are retrieved to determine the new suggestion candidate camera settings in relation to the new field of view 1412. In one example embodiment, an adjustment difference between the current and new camera settings is calculated and checked if the adjustment difference is greater than a pre-configured minimum change threshold. If the adjustment difference is greater than the minimum change threshold, a determination on whether to suggest zoom adjustment (change in magnification) is carried out; else if the adjustment difference is smaller than the minimum change threshold, indicating that not much change in camera setting is required, for example, the focus area may already near to or at the reference centralized portion or a center portion of the detection area, no further action or process will be carried out.

For example, the current camera tilt angle in relation to the current field of view 1402 is 30° and it is determined that a new camera tilt angle in relation to the new field of view 1412 of 45° is required to reposition the focus rectangle 1404 to the reference centralized portion, and the camera angle change percentage (adjustment difference) is (45°−30°)/30° or 0.5 or 50%. In this case, the pre-configured minimum camera angle change percentage threshold is 0.3 or 30%. As the adjustment difference is greater than the minimum change threshold, the camera angle suggestion candidate of 45° become a suggestion.

A determination on whether to suggest zoom adjustment is carried out, for example, by determining profile's zoom-in value derived from the camera setting. If the profile's zoom-in value is true, a zoom calculation of focus rectangle to full resolution may be appended in the new suggestion candidate settings. If the profile's zoom-in value is false, no suggestion in zoom or change in magnification will be included in the new suggestion candidate settings.

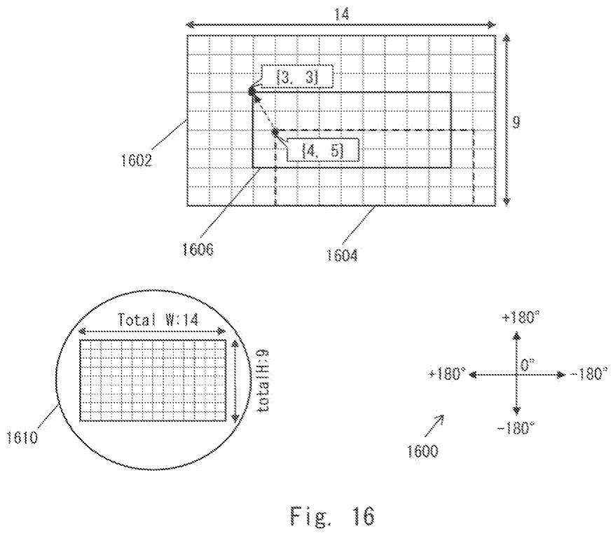

Additionally, a zoom adjustment suggestion may also be determined based on the resolution of the person appearances detected from the input images. FIG. 15 shows a change in a magnification of an image capturing device for adjusting a detection area according to an example embodiment of the present disclosure. In this example embodiment, it is determined that the detected person appearances across multiple input images 1502 take up 30 pixels (or certain number of segmented portions) in average. In such case, a change in magnification may be included in the new suggestion candidate settings, such that the person appearances detected in subsequent images 1506 captured by the camera will have a resolution at least or close to a certain pre-configured resolution.

Additionally or alternatively, there may be a pre-configured center portion within a detection area or a pre-configured focus area size 1506. When the size of focus rectangle 1504 is larger or smaller than the pre-configured center portion (or size 1506), a change in magnification of the camera to zoom in or out such that the focus rectangle will fit into or match the pre-configured center portion or size 1506.

Subsequently, calculated camera setting, i.e., pan+tilt+zoom, a re-adjustment suggestion is provided.

According to an example embodiment, camera view pan and tilt adjustment can be calculated using pixel coordinate difference and angular field of view (AFOV). FIG. 16 shows an example camera view adjustment corresponding to an adjustment in the detection area to reposition a focus area 1604 to a reference centralized portion 1606 using pixel coordinate difference and angular field of view (AFOV) according to an example embodiment of the present disclosure. In this example embodiment, the x- and y-coordinates of top left corner of the focus area 1604, i.e., {4, 5}, and the reference centralized portion 1606, i.e., {3, 3}, are determined. With the x- and y-coordinates, the pixel coordinate difference between the focus area 1604 and the reference centralized portion 1606 can be calculated using the following equations:

$$\begin{matrix}( Equation 4 ) & \\ adjX = newX - orgX & Equation ( 4 )\end{matrix}$$

$$\begin{matrix}( Equation 5 ) & \\ adjY = newY - orgY & Equation ( 5 )\end{matrix}$$

where adjX is the pixel coordinate difference in X axis (horizontal axis) and adjY is pixel coordinate difference in Y axis (vertical axis) between the focus area 1604 and the reference centralized portion 1606, newX and newY refers x- and y-coordinates of the reference centralized portion 1606, respectively, and orgX and orgY refers the x- and y-coordinates of the focus area 1602, respectively.

Further, current camera settings such as sensor width (14.5927 mm) and sensor height (8.2084 mm) of camera sensor 1610 as well as focal length (2.8 mm) are also retrieved.

Both horizontal AFOV and vertical AFOV can be calculated using the following equations:

$$\begin{matrix}( Equation 6 ) & \\ Horizontal AFOV = 2 \times {tan}^{- 1} ( \frac{W}{2 f} ) & Equation ( 6 )\end{matrix}$$

$$\begin{matrix}( Equation 7 ) & \\ Vertical AFOV = 2 \times {tan}^{- 1} ( \frac{H}{2 f} ) & Equation ( 7 )\end{matrix}$$

$$\begin{matrix}( Equation 8 ) & \\ Horizontal Angle per Pixel = \frac{Horizontal AFOV}{totalW} & Equation ( 8 )\end{matrix}$$

$$\begin{matrix}( Equation 9 ) & \\ Vertical Angle per Pixel = \frac{Vertical AFOV}{totalW} & Equation ( 9 )\end{matrix}$$

where W is sensor width, H is sensor height, f is focal length, totalW is total width of the image or detection area 1602 (14 in this case) and total H is the total height of the image or detection area 1602 (9 in this case). In this example embodiment, the calculated horizontal and vertical AFOVs are 138.011° and 111.3941° respectively.

Camera pan adjustment (around horizontal axis) and tilt adjustment (around vertical axis) can be calculated using the following equations:

$$\begin{matrix}( Equation 10 ) & \\ \begin{matrix}Camera pan adjustment = Horizontal Angle per Pixel \times \\ adjX \times inverse direction \\ = ( 138.011 ° / 14 ) \times ( - 1 ) \times ( - 1 ) \\ = 9.8579 °\end{matrix} & Equation ( 10 )\end{matrix}$$

$$\begin{matrix}( Equation 11 ) & \\ \begin{matrix}Camera tilt adjustment = Vertical Angle per Pixel \times \\ adjY \times inverse direction \\ = ( 111.3941 ° / 9 ) \times ( - 2 ) \times ( 1 - ) \\ = 24.7542 °\end{matrix} & Equation ( 11 )\end{matrix}$$

where an inverse direction factor of −1 is applied to convert the adjustment for the purpose of hardware implementation. In this example embodiment, the calculated camera pan and tilt adjustments are 9.8579° and 24.4542°, respectively.

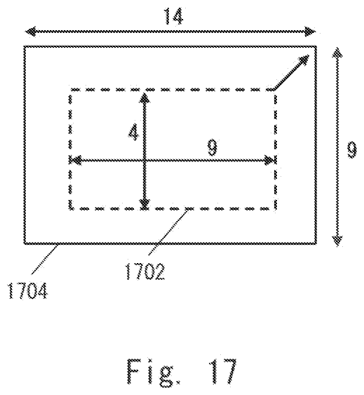

FIG. 17 shows example camera zoom adjustment corresponding to an adjustment in a detection area according to an example embodiment of the present disclosure. A zoom adjustment in terms of width and height is calculated based on the size of focus rectangle 1702 and the resolution of full image (current detection area) 1704 using the following equations (12) and (13):

$$\begin{matrix}( Equation 12 ) & \\ adjW = \frac{fullResW}{focusW} & Equation ( 12 )\end{matrix}$$

$$\begin{matrix}( Equation 13 ) & \\ adjH = \frac{fullResH}{focusH} & Equation ( 13 )\end{matrix}$$

where fullResW is width of full image resolution, fullResH is height of full image resolution, focusW is width of focus area, focusH is height of focus area. A camera zoom-in or magnification factor can then be determined by taking the lower value between the adjW value and adjH value, as illustrated in equation (14) below:

$$\begin{matrix}( Equation 14 ) & \\ Camera Zoom - In Factor = min ( adjW , adjH ) & Equation ( 14 )\end{matrix}$$

In this example embodiment, the full image resolution (width×height) is 14×9, and the focus area resolution is 9×4. The calculated adjW and adjH are 1.5555 and 2.25 respectively using equations (12) and (13), and the calculated camera zoom-in factor using equation (14) is 1.5555.

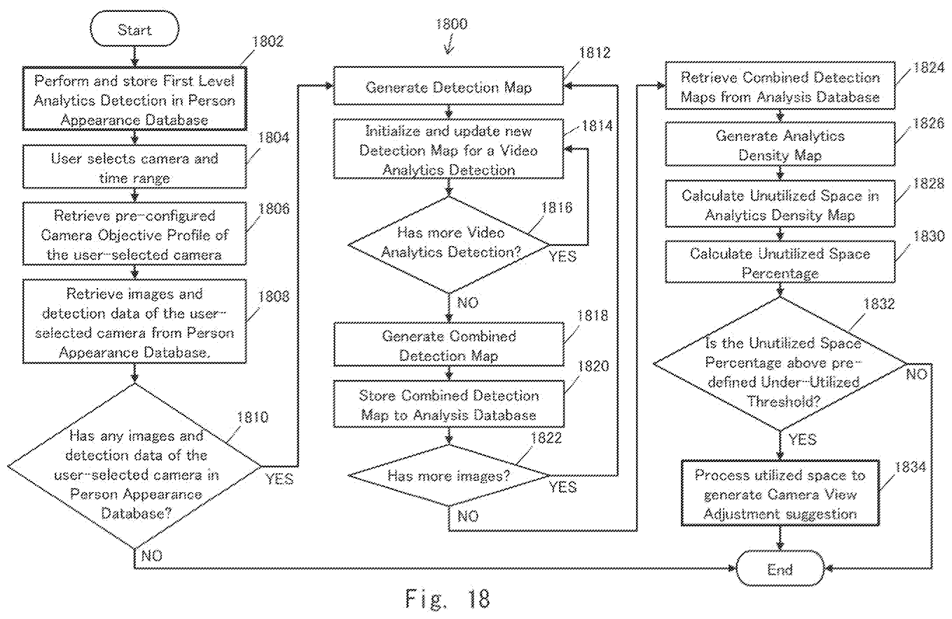

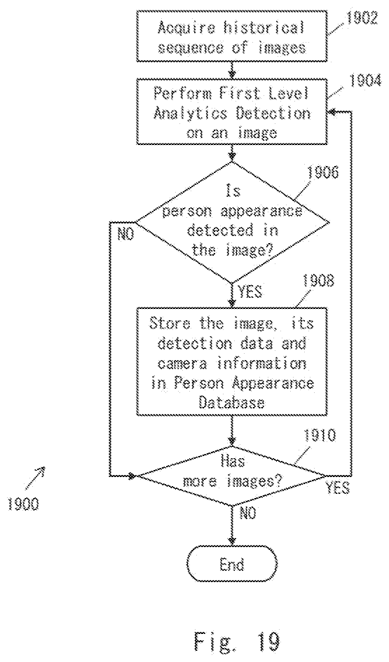

FIG. 18 shows a flow chart 1800 illustrating a process of adaptively adjusting a detection area of an image to be captured by an image capturing device according to an example embodiment of the present disclosure. In step 1802, step of performing and storing a first level analytics detection in a person appearance database is carried out. The step 1802 is further elaborated in FIG. 19 and its accompanying description. In step 1804, a step of selecting a camera among a plurality of camera in a system and a time range is carried out by a user. In step 1806, a step of retrieving the pre-configured camera objective profile of the user-selected camera is carried out. In step 1808, a step of retrieving, from the person appearance database, images and detection data of the user-selected camera within the selected time range is carried out. In step 1810, it is determined if there are any more images and detection data of the user selected camera within the selected time range in the person appearance database. If there is none, the process may end; otherwise step 1812 is carried out.

In step 1812, a step of generating a detection map from an image and its detection data. In step 1814, a step of initializing and updating new detection map for a video analytics detection based on the weightage defined in the selected camera objective profile is carried out. In step 1816, it is determined if there is another video analytics detection defined in the camera objective profile. If the determination is positive, step 1814 is carried out for the other video analytics detection. If there is none, step 1818 is carried out.

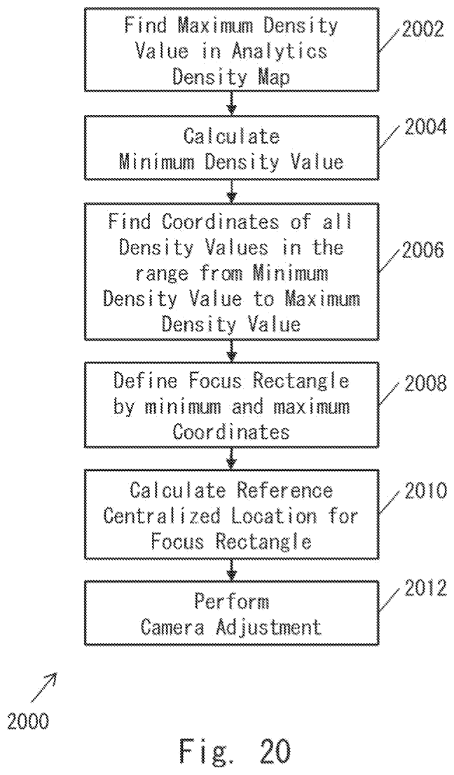

In step 1818, a step of generating a combined detection map is carried out by summing up all detection map of the image generated and updated in steps 1812 and 1814. In step 1820, a step of storing the combined detection map generated to analysis database in step 1818 is carried out. In step 1822, it is determined if there is any other image. If the determination is positive, steps 1812-1822 are carried out using the other image If there is none, step 1824 is carried out. In step 1824, a step of retrieving combined detection maps from analysis database generated from images of the user-selected camera and time range is carried out. In step 1826, a step of generating an analytics density map is carried out by summing up the combined detection maps retrieved in step 1824. In step 1828, a step of calculating utilized space in analytic density map is carried out. In step 1830, a step of calculating an unutilized space percentage is carried out. In step 1832, it is determined if the unutilized space percentage is above a pre-defined under-utilized threshold. If the unutilized space percentage is lower than a pre-defined under-utilized threshold, the process may end; otherwise, step 1834 is carried out where a step of processing the utilized space to generate a camera view adjustment suggestion is carried out. The step 1834 is further elaborated in FIG. 20 and its accompanying description.

FIG. 19 shows a flow chart 1900 illustrating a process of performing and storing a first level analytics detection in person appearance database 1802 in FIG. 18 according to an example embodiment of the present disclosure. The step 1802 may start by acquiring historical sequence of images in step 1902. In step 1904, a step of performing first level analytics detection is carried out on an image. In step 1906, it is determined if at least one person appearance is detected in the images based on the first level analytics detection. If no person appearance is detected, step 1910 is carried out; otherwise step 1908 is carried out. In step 1908, a step of storing the image, its detection data and camera information in a person appearance database is carried out. In step 1910, it is determined if there is any other image. If the determination is positive, steps 1904-1910 are carried out using the other image. If there is none, the process may end.

FIG. 20 shows a flow chart 2000 illustrating a process of processing utilized space to generate camera view adjustment suggestion 1834 in FIG. 18 according to an example embodiment of the present disclosure. In step 2002, a step of finding a maximum density value in an analytics density map is carried out. In step 2004, a step of calculating minimum density value is carried out. In step 2006, a step of finding coordinates of all density values in the range from minimum density value to maximum density value is carried out. In step 2008, a step of defining a focus rectangle by minimum and maximum coordinates is carried out. In step 2010, step of calculating a reference centralized portion for focus rectangle is carried out. In step 2012, a step of calculating and performing camera adjustment is carried out.

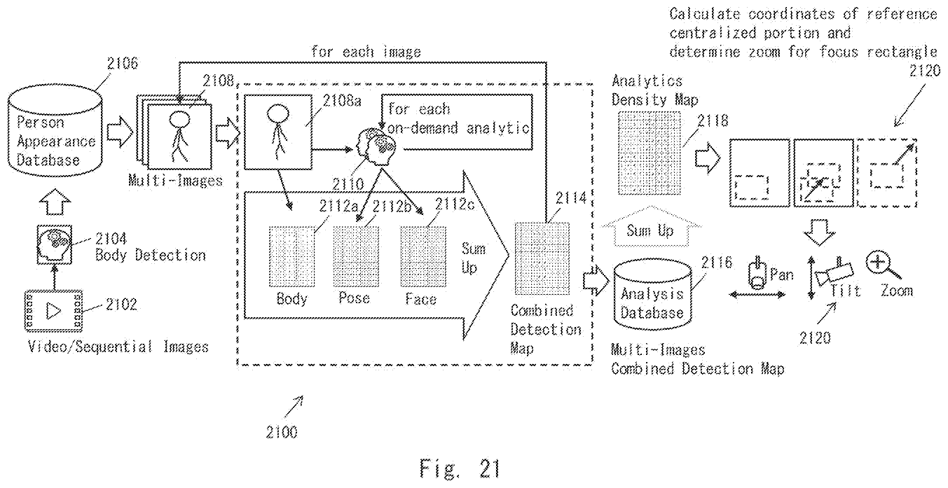

FIG. 21 shows a schematic diagram 2100 illustrating an overview of a process of adaptively adjusting a detection area of an image to be captured by an image capturing device according to an example embodiment of the present disclosure. Video and/or sequential images 2102 may be taken by multiple image capturing devices and each image is subjected to a first level analytics detection (in this case body detection 2104) to identify person appearances from each image. The images with at least one person appearance are then stored in person appearance database 2106. A user may specify or select a time range and a camera, and the images 2108 captured by the camera within the time range are retrieved.

For each retrieved image 2108a, a detection map 2112a may first be generated showing measures of appearances detected based on the first level analytics detection (body detection) in all portions of the image. Based on the objective profile of the selected camera, further on-demand video analytics detection 2110 may be required. In this case, additional video analytics on pose and face detections are required, and thus detection maps 2112b and 2112c are generated showing measures of appearances detected based on the respective additional video analytics detections. Optionally, a combined detection map is also generated for each processed image by summing up all the detections map 2112a-2112c generated based on multiple analytics detections before storing into an analysis database 2116.

Subsequently, after all the retrieved images 2108 are processed and the detection maps (and combined detection maps 2114) generated from the retrieved images 2108 are stored in the analysis database 2116, an analytics density map 2118 is generated by summing up the detections map (or combined detection maps). The analytics density map 2118 is then used to identify a focus rectangle and calculate coordinates of reference centralized portion for repositioning the focus rectangle and determine if zoom adjustment is required. The required camera pan and tilt adjustments as well as zoom adjustment 2120 to adjust the field of view of the selected camera and reposition the focus area to the center portion of the adjusted field of view are then calculated. The pan, tilt and zoom adjustments are then carried out to adjust the field of view of the selected camera such that subsequent images of the selected camera will be taken under the adjusted detection area.

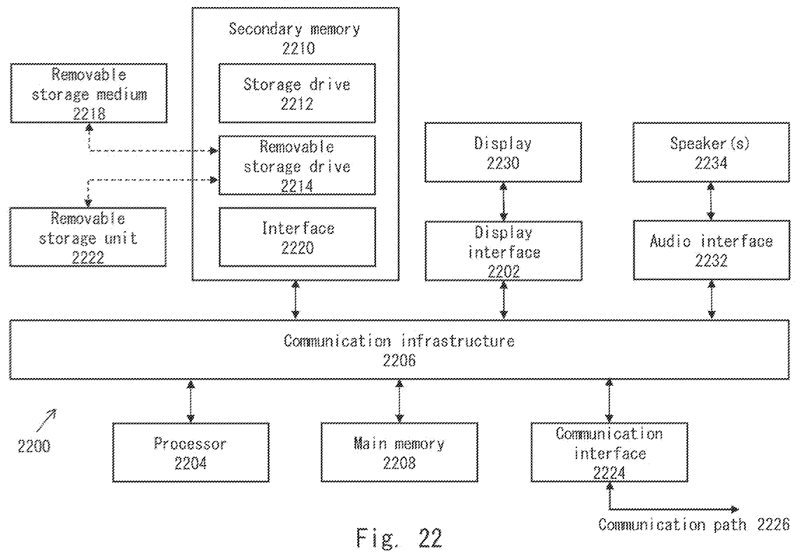

FIG. 22 shows a schematic diagram of an exemplary computing device 2200, hereinafter interchangeably referred to as a computer system 2200, where one or more such computing device 2200 may be used or suitable for use to execute the method in FIG. 3 and implement the apparatus in FIG. 4. The following description of the computing device 2200 is provided by way of example only and is not intended to be limiting.

As shown in FIG. 22, the example computing device 2200 includes a processor 2204 for executing software routines. Although a single processor is shown for the sake of clarity, the computing device 2200 may also include a multi-processor system. The processor 2204 is connected to a communication infrastructure 2206 for communication with other components of the computing device 2200. The communication infrastructure 2206 may include, for example, a communications bus, cross-bar, or network.

The computing device 2200 further includes a main memory 2208, such as a random access memory (RAM), and a secondary memory 2210. The secondary memory 2210 may include, for example, a storage drive 2212, which may be a hard disk drive, a solid state drive or a hybrid drive and/or a removable storage drive 2214, which may include a magnetic tape drive, an optical disk drive, a solid state storage drive (such as a USB flash drive, a flash memory device, a solid state drive or a memory card), or the like. The removable storage drive 2214 reads from and/or writes to a removable storage medium 2218 in a well-known manner. The removable storage medium 2218 may include magnetic tape, optical disk, non-volatile memory storage medium, or the like, which is read by and written to by removable storage drive 2214. As will be appreciated by persons skilled in the relevant art(s), the removable storage medium 2218 includes a computer readable storage medium having stored therein computer executable program code instructions and/or data.

In an alternative implementation, the secondary memory 2210 may additionally or alternatively include other similar means for allowing computer programs or other instructions to be loaded into the computing device 2200. Such means can include, for example, a removable storage unit 2222 and an interface 2220.

Examples of a removable storage unit 2222 and interface 2220 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 2222 and interfaces 2220 which allow software and data to be transferred from the removable storage unit 2222 to the computer system 2200.

The computing device 2200 also includes at least one communication interface 2224. The communication interface 2224 allows software and data to be transferred between computing device 2200 and external devices via a communication path 2226. In various example embodiments of the inventions, the communication interface 2224 permits data to be transferred between the computing device 2200 and a data communication network, such as a public data or private data communication network. The communication interface 2224 may be used to exchange data between different computing devices 600 which such computing devices 2200 form part an interconnected computer network. Examples of a communication interface 2224 can include a modem, a network interface (such as an Ethernet card), a communication port (such as a serial, parallel, printer, GPIB, IEEE 1394, RJ45, USB), an antenna with associated circuitry and the like. The communication interface 2224 may be wired or may be wireless. Software and data transferred via the communication interface 2224 are in the form of signals which can be electronic, electromagnetic, optical or other signals capable of being received by communication interface 2224. These signals are provided to the communication interface via the communication path 2226.

As shown in FIG. 22, the computing device 2200 further includes a display interface 2202 which performs operations for rendering images to an associated display 2230 and an audio interface 2232 for performing operations for playing audio content via associated speaker(s) 2234.

As used herein, the term “computer program product” may refer, in part, to removable storage medium 2218, removable storage unit 2222, a hard disk installed in storage drive 2212, or a carrier wave carrying software over communication path 2226 (wireless link or cable) to communication interface 2224. Computer readable storage media refers to any non-transitory, non-volatile tangible storage medium that provides recorded instructions and/or data to the computing device 2200 for execution and/or processing. Examples of such storage media include magnetic tape, CD-ROM, DVD, Blu-ray Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 2200. Examples of transitory or non-tangible computer readable transmission media that may also participate in the provision of software, application programs, instructions and/or data to the computing device 2200 include radio or infra-red transmission channels as well as a network connection to another computer or networked device, and the Internet or Intranets including e-mail transmissions and information recorded on Websites and the like.

The computer programs (also called computer program code) are stored in main memory 2208 and/or secondary memory 2210. Computer programs can also be received via the communication interface 2224. Such computer programs, when executed, enable the computing device 2200 to perform one or more features of example embodiments discussed herein. In various example embodiments, the computer programs, when executed, enable the processor 1207 to perform features of the above-described example embodiments. Accordingly, such computer programs represent controllers of the computer system 2200.

Software may be stored in a computer program product and loaded into the computing device 2200 using the removable storage drive 2214, the storage drive 2212, or the interface 2220. The computer program product may be a non-transitory computer readable medium. Alternatively, the computer program product may be downloaded to the computer system 2200 over the communication path 2226. The software, when executed by the processor 2204, causes the computing device 2200 to perform the necessary operations to execute the method as shown in FIG. 3 and implement the apparatus in FIG. 4.

It is to be understood that the example embodiment of FIG. 22 is presented merely by way of example to explain the operation and structure of the apparatus 2200. Therefore, in some example embodiments one or more features of the computing device 2200 may be omitted. Also, in some example embodiments, one or more features of the computing device 2200 may be combined together. Additionally, in some example embodiments, one or more features of the computing device 2200 may be split into one or more component parts.

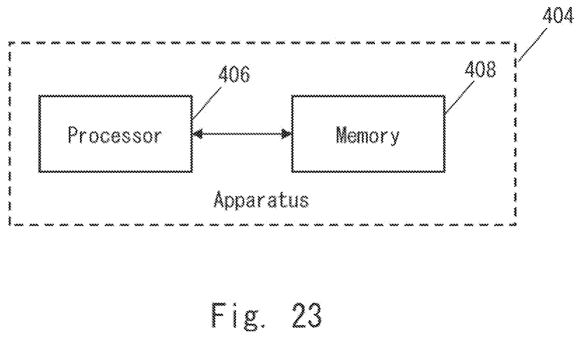

FIG. 23 shows a block diagram illustrating an apparatus 404 for adaptively adjusting a detection area of an image to be captured by an image capturing device 402 according to various example embodiments of the present disclosure. The apparatus 404 comprises at least one processor 406 and at least one memory 408 including computer program code.

It will be appreciated by a person skilled in the art that numerous variations and/or modifications may be made to the present invention as shown in the specific example embodiments without departing from the spirit or scope of the invention as broadly described. The present example embodiments are, therefore, to be considered in all respects to be illustrative and not restrictive.

This application is based upon and claims the benefit of priority from Singaporean patent application number 10202111442R, filed on Oct. 14, 2021, the disclosure of which is incorporated herein in its entirety by reference.

### SUPPLEMENTARY NOTE

The whole or part of the example embodiments disclosed above can be described as, but not limited to, the following supplementary notes.

### Supplementary Note 1

A method executed by a computer for adaptively adjusting a detection area of an image to be captured by an image capturing device including:
detecting appearances of one or more persons in the detection area from each of a plurality of input images previously captured by the image capturing device over a period of time;
generating a first map corresponding to the detection area based on the respective appearances of the one or more persons, wherein the first map comprises a first measure of the appearances of the one or more persons detected in each of a plurality of portions of the detection area across the plurality of the input images;
determining if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjusting the detection area such that a focus area within the detection area which comprises at least a part of utilized portions of the plurality of portions is positioned at or near to a center of the adjusted detection area of the image to be captured by the image capturing device in response to the determination.

### Supplementary Note 2

The method of supplementary note 1, further including:
generating, from each of the plurality of input images, more than one second map, wherein
each of more than one second map corresponds to the detection area and comprises a different second measure of the appearances of the one or more persons detected in each of the plurality of portions of the detection area from the each of the plurality of input images based on at least one of a facial feature, a body part, a characteristic or a motion of the one or more persons, and
the generating the first map includes determining the first measure of the appearances of the one or more persons in the first map detected in each of the plurality of portions of the detection area across the plurality of the input images based on the respective second measures of the appearances of the one or more persons detected in the each of the plurality of portions of the detection area in relation to the more than one second map generated from the each of the plurality of input image.

### Supplementary Note 3

The method of supplementary note 2, further including:
determining the second measure of the appearances of the person based on a count of the appearances of the one or more persons detected in the each of the plurality of portions of the detection area from the each of the plurality of input images based on the at least one of the body part, the characteristic or the motion of the one or more persons, and a detection weightage pre-configured for an appearance detected based on the at least one of the facial feature, the body part, the characteristic or the motion by the image capturing device.

### Supplementary Note 4

The method of supplementary note 2 or 3, further including:

generating a third map corresponding to the detection area, wherein the third map comprises a third measure of the appearances of the one or more persons detected in each of the plurality of portions of the detection area in the each of the plurality of input images, the third measure is a sum of the respective second measures of the appearances of the one or more persons of the more than one second map detected in the each of the plurality of portions of the detection area from the each of the plurality of input images; and
wherein the generating the first map includes determining the first measure of the appearances of the one or more persons in the first map detected in each of the plurality of portions of the detection area across the plurality of the input images based on the respective third measures of the appearances of the one or more persons detected in the each of the plurality of portions of the detection area in relation to the third map generated from the plurality of input images.

### Supplementary Note 5

The method of any one of supplementary notes 1-4, further including: determining if each of the at least a part of the utilized portions is associated with a measure of the appearances of the one or more persons that is equal or greater than a threshold measure of the appearances of the one or more persons.

### Supplementary Note 6

The method of supplementary note 5, further including:
determining a highest measure of the appearances of the one or more persons among the first measures of the appearances of the one or more persons generated in the first map; and
calculating the threshold measure of the appearances of the person based on the highest measure of the appearances of the one or more persons.

### Supplementary Note 7

The method of any one of supplementary notes 1-6, wherein the adjusting the detection area includes at least one of:
rotating the image capturing device around a horizontal and/or vertical axis to change a device angle of the image capturing device in relation to the detection area; and
increasing or decreasing a magnification of the image capturing device such that the focus area takes up a pre-configured center portion around the center of the adjusted detection area of the image to be captured by the image capturing device.

### Supplementary Note 8

The method of any one of supplementary notes 1-7, further including:
calculating an amount of a detection area adjustment required to move the focus area to a center of the detection area; and
determining if the amount of the detection area adjustment is greater than a pre-configured minimum adjustment threshold, wherein the adjusting the detection area is carried out in response to the determination of the amount of the detection being greater than the pre-configured minimum adjustment threshold.

### Supplementary Note 9

An apparatus for adaptively adjusting a detection area of an image to be captured by an image capturing device comprising:
at least one processor; and
at least one memory including computer program code: wherein
the at least one memory and the computer program code are configured to, with at least one processor, cause the apparatus at least to:
detect appearances of one or more persons in the detection area from each of a plurality of input images previously captured by the image capturing device over a period of time;
generate a first map corresponding to the detection area based on the respective appearances of the one or more persons, wherein the first map comprises a first measure of the appearances of the one or more persons detected in each of a plurality of portions of the detection area across the plurality of the input images;
determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjust the detection area such that a focus area within the detection area which comprises at least a part of utilized portions of the plurality of portions is positioned at or near to a center of the adjusted detection area of the image to be captured by the image capturing device in response to the determination.

### Supplementary Note 10

The apparatus of supplementary note 9, wherein the at least one memory and the computer program code are configured to, with at least one processor, cause the apparatus at least to generate, from each of the plurality of input images, more than one second map, wherein each of more than one second map corresponds to the detection area and comprises a different second measure of the appearances of the one or more persons detected in each of the plurality of portions of the detection area from the each of the plurality of input images based on at least one of a facial feature, a body part, a characteristic or a motion of the one or more persons, and
the generating the first map includes determining the first measure of the appearances of the one or more persons in the first map detected in each of the plurality of portions of the detection area across the plurality of the input images based on the respective second measures of the appearances of the one or more persons detected in the each of the plurality of portions of the detection area in relation to the more than one second map generated from the each of the plurality of input image.

### Supplementary Note 11

The apparatus of supplementary note 9, wherein the at least one memory and the computer program code are configured to, with at least one processor, cause the apparatus at least to:
determine the second measure of the appearances of the one or more persons based on a count of the appearances of the one or more persons detected in the each of the plurality of portions of the detection area from the each of the plurality of input images based on the at least one of the body part, the characteristic or the motion of the one or more persons, and a detection weightage pre-configured for an appearance detected based on the at least one of the facial feature, the body part, the characteristic or the motion by the image capturing device.

### Supplementary Note 12

The apparatus of supplementary note 10 or 11, wherein the at least one memory and the computer program code are configured to, with at least one processor, cause the apparatus at least to generate a third map corresponding to the detection area, wherein the third map comprises a third measure of the appearances of the one or more persons detected in each of the plurality of portions of the detection area in the each of the plurality of input images, the third measure is a sum of the respective second measures of the appearances of the one or more persons of the more than one second map detected in the each of the plurality of portions of the detection area from the each of the plurality of input images, and
the generating the first map includes determining the first measure of the appearances of the one or more persons in the first map detected in each of the plurality of portions of the detection area across the plurality of the input images based on the respective third measures of the appearances of the one or more persons detected in the each of the plurality of portions of the detection area in relation to the third map generated from the plurality of input images.

### Supplementary Note 13

The apparatus of any one of supplementary notes 9-12, wherein the at least one memory and the computer program code are configured to, with at least one processor, cause the apparatus at least to:
determine if each of the at least a part of the utilized portions is associated with a measure of the appearances of the one or more persons that is equal or greater than a threshold measure of the appearances of the one or more persons.

### Supplementary Note 14

The apparatus of supplementary note 13, wherein the at least one memory and the computer program code are configured to, with at least one processor, cause the apparatus at least to:
determine a highest measure of the appearances of the one or more persons among the first measures of the appearances of the one or more persons generated in the first map; and
calculate the threshold measure of the appearances of the one or more persons based on the highest measure of the appearances of the one or more persons.

### Supplementary Note 15

The apparatus of any one of supplementary notes 9-14, wherein the at least one memory and the computer program code are configured to, with at least one processor, cause the apparatus at least to perform at least one of:
rotating the image capturing device around a horizontal and/or vertical axis to change a device angle of the image capturing device in relation to the detection area; and
increasing or decreasing a magnification of the image capturing device such that the focus area takes up a pre-configured center portion around the center of the adjusted detection area of the image to be captured by the image capturing device.

### Supplementary Note 16

The apparatus of any one of supplementary notes 9-15, wherein the at least one memory and the computer program code are configured to, with at least one processor, cause the apparatus at least to:
calculate an amount of a detection area adjustment required to move the focus area to a center of the detection area; and
determine if the amount of the detection area adjustment is greater than a pre-configured minimum adjustment threshold, wherein the adjusting the detection area is carried out in response to the determination of the amount of the detection being greater than the pre-configured minimum adjustment threshold.

### Supplementary Note 17

A system for adaptively adjusting a detection area of an image to be captured by an image capturing device comprising the apparatus as claimed in any one of supplementary notes 9-16 and the image capturing device.

### Supplementary Note 18

A non-transitory computer readable medium storing a program for adaptively adjusting a detection area of an image to be captured by an image capturing device, wherein the program causes a computer at least to:
detect appearances of one or more persons in the detection area from each of a plurality of input images previously captured by the image capturing device over a period of time;
generate a first map corresponding to the detection area based on the respective appearances of the one or more persons, wherein the first map comprises a first measure of the appearances of the one or more persons detected in each of a plurality of portions of the detection area across the plurality of the input images;
determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjust the detection area such that a focus area within the detection area which comprises at least a part of utilized portions of the plurality of portions is positioned at or near to a center of the adjusted detection area of the image to be captured by the image capturing device in response to the determination.

### REFERENCE SIGNS LIST

100 Image
102 Camera
104 Appearance
105 View
106 Direction
110 Image
114 Person
116 Direction
118 Detection area
120, 120′ View, image
122, 122′ Focus area
200 Input image
200a˜200c Image
202a˜202c Person appearance
204a, 204b Person appearance
300 Method, Flow chart
400 System
402 Image capturing device
404 Apparatus
406 Processor
408 Memory
410 Database
500 System
502 Cameras
504 Images or video files
506 Video archival and retrieval system
508 Person appearance database
602 Camera 1
604a˜604d Retrieved input image
700 Flow diagram
703 Objective profile
704a˜704d Input image
705 Selected camera 1's resolution
706, 708 Detection map
710 Combined detection map
802 Combined detection maps
804 Analysis database
806 Analytic density map
902 Input images
906 2D analytic density map
1004 Unutilized portion or space
1206 Focus rectangle, Rectangular area
1207 Processor
1302 Detection area, Detection map
1304 Focus rectangle, Rectangular area
1306 Reference centralized portion
1400 Camera
1402 Current field of view
1404 Focus rectangle, Rectangular area
1412 New field of view
1502 Input image
1504 Focus rectangle
1506 Subsequent images, Pre-configured focus area size, Pre-configured center portion or size
1602 Detection area or focus area
1604 Focus area
1606 Reference centralized portion
1610 Camera sensor
1702 Focus rectangle
1704 Full image
1800 Flow chart
1900 Flow chart
2000 Flow chart
2100 Schematic diagram
2102 Video images/Sequential images
2104 Body detection
2106 Person appearance database
2108, 2108a Retrieved images
2110 On-demand video analytics detection
2112a˜2112c Detection map
2114 Combined detection map
2116 Analysis database
2118 Analytics density map
2120 Zoom adjustment
2200 Computer system, computer device or apparatus
2202 Display interface
2204 Processor
2206 Communication infrastructure
2208 Main memory
2210 Secondary memory
2212 Storage drive
2214 Removable storage drive
2218 Removable storage medium
2220 Interface
2222 Removable storage unit
2224 Communication interface
2226 Communication path
2230 Display
2232 Audio interface
2234 Speaker(s)

What is claimed is:

1. A method executed by a computer for adaptively adjusting a detection area of an image to be captured by an image capturing device including:
detecting appearances of one or more persons in the detection area from each of a plurality of input images previously captured by the image capturing device over a period of time;
generating a first map corresponding to the detection area based on the respective appearances of the one or more persons, wherein the first map comprises a first measure of the appearances of the one or more persons detected in each of a plurality of portions of the detection area across the plurality of the input images;
determining if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjusting the detection area such that a focus area within the detection area which comprises at least a part of utilized portions of the plurality of portions is positioned at or near to a center of the adjusted detection area of the image to be captured by the image capturing device in response to the determination.

2. The method of claim 1, further including:
generating, from each of the plurality of input images, more than one second map, wherein
each of more than one second map corresponds to the detection area and comprises a different second measure of the appearances of the one or more persons detected in each of the plurality of portions of the detection area from the each of the plurality of input images based on at least one of a facial feature, a body part, a characteristic or a motion of the one or more persons, and
the generating the first map includes determining the first measure of the appearances of the one or more persons in the first map detected in each of the plurality of portions of the detection area across the plurality of the input images based on the respective second measures of the appearances of the one or more persons detected in the each of the plurality of portions of the detection area in relation to the more than one second map generated from the each of the plurality of input image.

3. The method of claim 2, further including:
determining the second measure of the appearances of the person based on a count of the appearances of the one or more persons detected in the each of the plurality of portions of the detection area from the each of the plurality of input images based on the at least one of the body part, the characteristic or the motion of the one or more persons, and a detection weightage pre-configured for an appearance detected based on the at least one of the facial feature, the body part, the characteristic or the motion by the image capturing device.

4. The method of claim 2, further including:
generating a third map corresponding to the detection area, wherein the third map comprises a third measure of the appearances of the one or more persons detected in each of the plurality of portions of the detection area in the each of the plurality of input images, the third measure is a sum of the respective second measures of the appearances of the one or more persons of the more than one second map detected in the each of the plurality of portions of the detection area from the each of the plurality of input images; and
wherein the generating the first map includes determining the first measure of the appearances of the one or more persons in the first map detected in each of the plurality of portions of the detection area across the plurality of the input images based on the respective third measures of the appearances of the one or more persons detected in the each of the plurality of portions of the detection area in relation to the third map generated from the plurality of input images.

5. The method of claim 1, further including:
determining if each of the at least a part of the utilized portions is associated with a measure of the appearances of the one or more persons that is equal or greater than a threshold measure of the appearances of the one or more persons.

6. The method of claim 5, further including:
determining a highest measure of the appearances of the one or more persons among the first measures of the appearances of the one or more persons generated in the first map; and
calculating the threshold measure of the appearances of the person based on the highest measure of the appearances of the one or more persons.

7. The method of claim 1, wherein the adjusting the detection area includes at least one of:
rotating the image capturing device around a horizontal and/or vertical axis to change a device angle of the image capturing device in relation to the detection area; and
increasing or decreasing a magnification of the image capturing device such that the focus area takes up a pre-configured center portion around the center of the adjusted detection area of the image to be captured by the image capturing device.

8. The method of claim 1, further including:
calculating an amount of a detection area adjustment required to move the focus area to a center of the detection area; and
determining if the amount of the detection area adjustment is greater than a pre-configured minimum adjustment threshold, wherein the adjusting the detection area is carried out in response to the determination of the amount of the detection being greater than the pre-configured minimum adjustment threshold.

9. An apparatus for adaptively adjusting a detection area of an image to be captured by an image capturing device comprising:
at least one processor; and
at least one memory including computer program code, wherein
the at least one memory and the computer program code are configured to, with at least one processor, cause the apparatus at least to:
detect appearances of one or more persons in the detection area from each of a plurality of input images previously captured by the image capturing device over a period of time;
generate a first map corresponding to the detection area based on the respective appearances of the one or more persons, wherein the first map comprises a first measure of the appearances of the one or more persons detected in each of a plurality of portions of the detection area across the plurality of the input images;
determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjust the detection area such that a focus area within the detection area which comprises at least a part of utilized portions of the plurality of portions is positioned at or near to a center of the adjusted detection area of the image to be captured by the image capturing device in response to the determination.

10. The apparatus of claim 9, wherein the at least one memory and the computer program code are configured to, with at least one processor, cause the apparatus at least to generate, from each of the plurality of input images, more than one second map, wherein each of more than one second map corresponds to the detection area and comprises a different second measure of the appearances of the one or more persons detected in each of the plurality of portions of the detection area from the each of the plurality of input images based on at least one of a facial feature, a body part, a characteristic or a motion of the one or more persons, and
the generating the first map includes determining the first measure of the appearances of the one or more persons in the first map detected in each of the plurality of portions of the detection area across the plurality of the input images based on the respective second measures of the appearances of the one or more persons detected in the each of the plurality of portions of the detection area in relation to the more than one second map generated from the each of the plurality of input image.

11. The apparatus of claim 9, wherein the at least one memory and the computer program code are configured to, with at least one processor, cause the apparatus at least to:
determine the second measure of the appearances of the one or more persons based on a count of the appearances of the one or more persons detected in the each of the plurality of portions of the detection area from the each of the plurality of input images based on the at least one of the body part, the characteristic or the motion of the one or more persons, and a detection weightage pre-configured for an appearance detected based on the at least one of the facial feature, the body part, the characteristic or the motion by the image capturing device.

12. The apparatus of claim 10, wherein the at least one memory and the computer program code are configured to, with at least one processor, cause the apparatus at least to generate a third map corresponding to the detection area, wherein the third map comprises a third measure of the appearances of the one or more persons detected in each of the plurality of portions of the detection area in the each of the plurality of input images, the third measure is a sum of the respective second measures of the appearances of the one or more persons of the more than one second map detected in the each of the plurality of portions of the detection area from the each of the plurality of input images, and
the generating the first map includes determining the first measure of the appearances of the one or more persons in the first map detected in each of the plurality of portions of the detection area across the plurality of the input images based on the respective third measures of the appearances of the one or more persons detected in the each of the plurality of portions of the detection area in relation to the third map generated from the plurality of input images.

13. The apparatus of claim 9, wherein the at least one memory and the computer program code are configured to, with at least one processor, cause the apparatus at least to:
determine if each of the at least a part of the utilized portions is associated with a measure of the appearances of the one or more persons that is equal or greater than a threshold measure of the appearances of the one or more persons.

14. The apparatus of claim 13, wherein the at least one memory and the computer program code are configured to, with at least one processor, cause the apparatus at least to:
determine a highest measure of the appearances of the one or more persons among the first measures of the appearances of the one or more persons generated in the first map; and
calculate the threshold measure of the appearances of the one or more persons based on the highest measure of the appearances of the one or more persons.

15. The apparatus of claim 9, wherein the at least one memory and the computer program code are configured to, with at least one processor, cause the apparatus at least to perform at least one of:
rotating the image capturing device around a horizontal and/or vertical axis to change a device angle of the image capturing device in relation to the detection area; and
increasing or decreasing a magnification of the image capturing device such that the focus area takes up a pre-configured center portion around the center of the adjusted detection area of the image to be captured by the image capturing device.

16. The apparatus of claim 9, wherein the at least one memory and the computer program code are configured to, with at least one processor, cause the apparatus at least to:
calculate an amount of a detection area adjustment required to move the focus area to a center of the detection area; and
determine if the amount of the detection area adjustment is greater than a pre-configured minimum adjustment threshold, wherein the adjusting the detection area is carried out in response to the determination of the amount of the detection being greater than the pre-configured minimum adjustment threshold.

17. (canceled)

18. A non-transitory computer readable medium storing a program for adaptively adjusting a detection area of an image to be captured by an image capturing device, wherein the program causes a computer at least to:
detect appearances of one or more persons in the detection area from each of a plurality of input images previously captured by the image capturing device over a period of time;
generate a first map corresponding to the detection area based on the respective appearances of the one or more persons, wherein the first map comprises a first measure of the appearances of the one or more persons detected in each of a plurality of portions of the detection area across the plurality of the input images;
determine if a ratio of unutilized portions to the plurality of portions of the detection area exceeds a threshold ratio, wherein each of the unutilized portions is a portion of the plurality of portions of the detection area associated with no first measure of appearances or a first measure of appearances being zero, indicating no appearances of the one or more persons were detected in that portion across the plurality of input images; and
adjust the detection area such that a focus area within the detection area which comprises at least a part of utilized portions of the plurality of portions is positioned at or near to a center of the adjusted detection area of the image to be captured by the image capturing device in response to the determination.
